(19) United States
(12) Patent Application Publication
(10) Pub. No.: US 2018/0257202 A1
(43) Pub. Date: Sep. 13, 2018

(54) One-Way Ratchet Wrench

(71) Applicant: Hong Ann Tool Industries Co., Ltd., Taichung City (TW)

(72) Inventor: Cheng-Wei Su, Taichung City (TW)

(21) Appl. No.: 15/913,999

(22) Filed: Mar. 7, 2018

(30) Foreign Application Priority Data
Mar. 10, 2017 (TW) 106107946

(51) Int. Cl. B25B 13/46

(52) U.S. Cl. CPC B25B 13/463

(57) ABSTRACT

A one-way ratchet wrench includes a body and a ratchet device. The body includes first and second compartments. The second compartment includes a first pivotal portion and a first moving portion. The ratchet device includes a ratchet wheel and a pawl. The ratchet wheel is mounted in the first compartment and is unidirectionally rotatable in relative to the body about a rotation axis. The pawl is mounted in the second compartment and includes a second pivotal portion and a second moving portion. The second pivotal portion is disposed in the first pivotal portion. The pawl is rotatable in relative to the body about a pivotal axis. The second moving portion is mounted in the first moving portion and is pivotable in relative to the body. The pawl is in face contact with the body for withstanding a reactive force during the operating process.

### BACKGROUND OF THE INVENTION

The present invention relates to a ratchet wrench and, in particular, to a one-way ratchet wrench.

Taiwan Utility Model Patent No. M534660 discloses a ratchet structure of the ratchet wrench (10), which includes a main body (11), a pawl (12), a spring (13), a ratchet wheel (14), and a C-shaped ring. The pawl (12) has a dovetail assembled-recess (126) formed on an assembled face (125). The dovetail assembled-recess (126) penetrates through a first plane (123) to form an enter opening (128), whereby the spring (13) may be mounted to the pawl (12) via the enter opening (128) and be secured by an internal conical inclined face (127) of the dovetail assembled-recess (126).

However, the pawl (12) of the above ratchet structure slides in a compartment (113) to provide a ratchet function. The friction between the pawl (12) and an internal wall of the compartment (113) and the dirty entering the compartment (113) will cause the pawl (12) not working smoothly.

Thus, a need exists for a novel one-way ratchet wrench with easily recognizable size indicia to mitigate and/or obviate the above disadvantages.

### SUMMARY OF THE INVENTION

A one-way ratchet wrench according to the present invention includes a body and a ratchet device. The body includes a first compartment and a second compartment. The second compartment includes a first pivotal portion and a first moving portion. The first pivotal portion has a first sliding face disposed on an internal wall of the first pivotal portion. The first compartment and the first moving portion intercommunicate with each other.

The ratchet device includes a ratchet wheel and a pawl. The ratchet wheel is mounted in the first compartment and is unidirectionally rotatable in relative to the body about a rotation axis. The ratchet wheel includes a plurality of first abutting faces arranged around an external circumference of the ratchet wheel. The pawl is mounted in the second compartment. The pawl includes a second pivotal portion and a second moving portion. The second pivotal portion is disposed in the first pivotal portion. The second pivotal portion has a second sliding face disposed on an external wall of the second pivotal portion. The second sliding face is slidable in relative to and abuts in face contact with the first sliding face. The second moving portion includes a second abutting face. The pawl pivots in relative to the body about a pivotal axis while the second sliding face slides in relative to the first sliding face, and the second moving portion is mounted in the first moving portion and is pivotable in relative to the body to cause the second abutting face abutting in face contact with one of the plurality of first abutting faces or disengaging from the ratchet wheel.

In an example, the pivotal axis is parallel to the rotation axis.

In an example, a phantom datum plane is perpendicular to the rotation axis and the pivotal axis and passes through the plurality of first abutting faces and the second abutting face. A first phantom line on the phantom datum plane is formed between the rotation axis and a contact point between the first and second abutting faces. A second phantom line on the phantom datum plane is formed between the pivotal axis and the contact point between the first and second abutting faces. An included angle between the first and second phantom lines is greater than 90 degrees and less than 130 degrees.

In an example, the included angle between the first and second phantom lines is greater than 110 degrees and less than 120 degrees.

In an example, the second compartment further includes a neck disposed between the first pivotal portion and the first moving portion. A minimum width of the neck is less than a maximum width of the first pivotal portion and a maximum width of the second pivotal portion along a radial direction of the pivotal axis.

In an example, the body further includes a third compartment disposed at a side of the second compartment opposite to the first compartment. The third compartment intercommunicates with the first moving portion of the second compartment. The ratchet device further includes an elastic member disposed in the third compartment. An end of the elastic member abuts a bottom face of the third compartment opposite to the second compartment, and another end of the elastic member abuts a side of the pawl opposite to the ratchet wheel.

In an example, the ratchet wheel further includes a plurality of engaging protrusions arranged around the external circumference of the ratchet wheel. The number of the plurality of engaging protrusions is equal to the number of the plurality of first abutting faces. The plurality of first abutting faces is aligned to the plurality of engaging protrusions and is formed on external faces of the engaging protrusions.

In another example, the ratchet wheel further includes a plurality of engaging recesses arranged around the external circumference of the ratchet wheel. The number of the plurality of engaging recesses is equal to the number of the plurality of first abutting faces. The plurality of first abutting faces is aligned to the plurality of engaging recesses and is formed on internal faces of the engaging recesses.

In an example, the plurality of first abutting faces and the second abutting face are flat, and the second abutting face is in face contact with one of the plurality of first abutting faces.

In an example, the first pivotal portion is a round hole, and the second pivotal portion is a cylinder corresponding to the first pivotal portion.

### BRIEF DESCRIPTION OF THE DRAWINGS

FIG. 1 is a perspective view of a one-way ratchet wrench of a first embodiment according to the present invention.

FIG. 2 is an exploded, perspective view of the one-way ratchet wrench of FIG. 1.

FIG. 3 is a cross-sectional view of the one-way ratchet wrench of FIG. 1.

FIG. 4 is another cross-sectional view of the one-way ratchet wrench of FIG. 1.

FIG. 5 is a perspective view of a one-way ratchet wrench of a second embodiment according to the present invention.

FIG. 6 is an exploded, perspective view of the one-way ratchet wrench of FIG. 5.

FIG. 7 is a cross-sectional view of the one-way ratchet wrench of FIG. 5.

FIG. 8 is a cross-sectional view of a one-way ratchet wrench of a third embodiment according to the present invention.

### DETAILED DESCRIPTION OF THE INVENTION

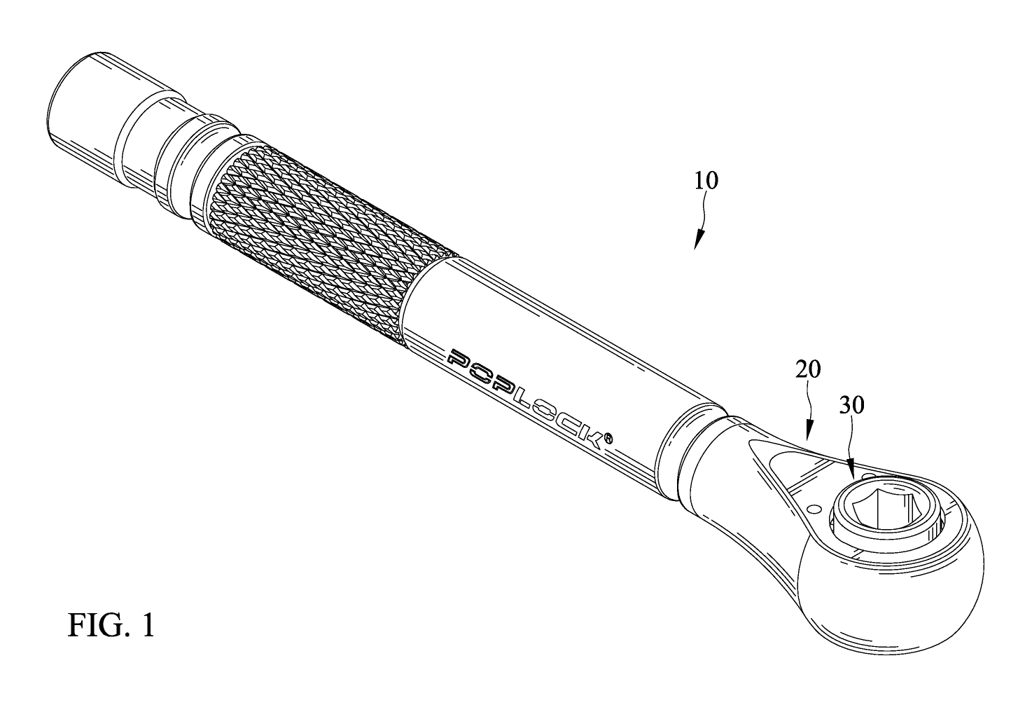

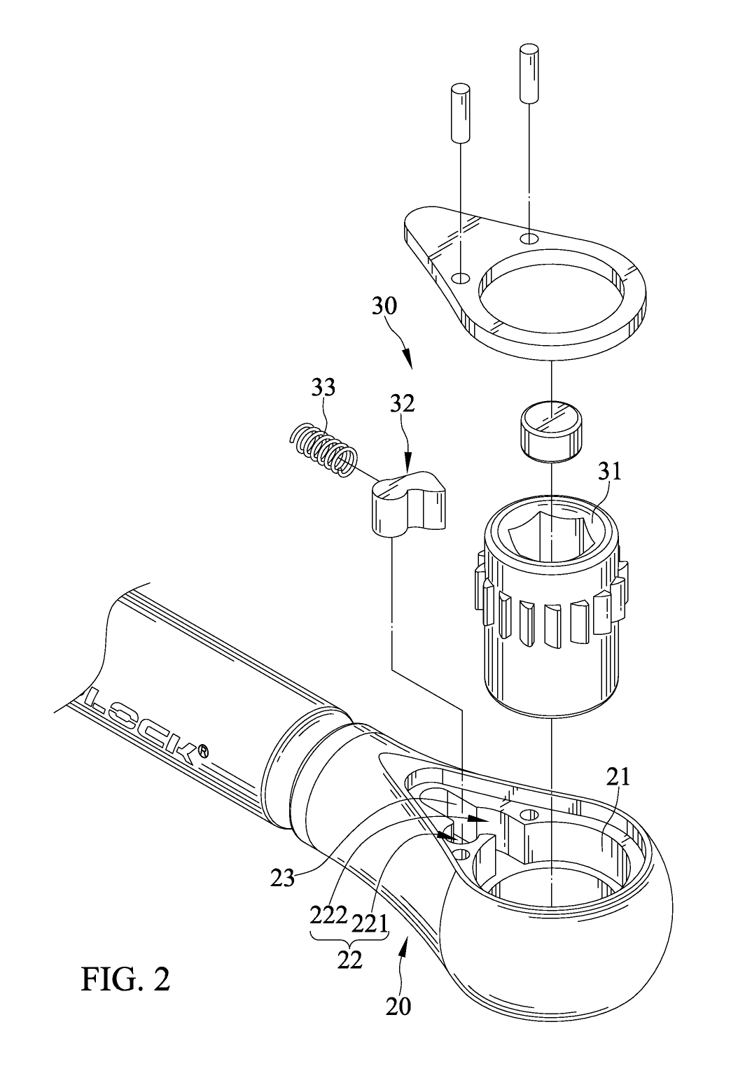

FIGS. 1-4 show a one-way ratchet wrench 10 of a first embodiment according to the present invention. The one-way ratchet wrench 10 includes a body 20 and a ratchet device 30.

Body 20 includes a first compartment 21 and a second compartment 22. Second compartment 22 includes a first pivotal portion 221, a first moving portion 222, and a neck 223 disposed between first pivotal portion 221 and first moving portion 222. First pivotal portion 221 is in the form of a round hole and has a first sliding face 224 disposed on an internal wall of first pivotal portion 221. First compartment 21 and first moving portion 222 of second compartment 22 intercommunicate with each other. A minimum width of neck 223 is less than a maximum width of first pivotal portion 221.

Body 20 further includes a third compartment 23 disposed at a side of second compartment 22 opposite to first compartment 21. Third compartment 23 intercommunicates with first moving portion 222 of second compartment 22.

Ratchet device 30 includes a ratchet wheel 31 and a pawl 32. Ratchet wheel 31 is mounted in first compartment 21 and is unidirectionally rotatable in relative to body 20 about a rotation axis O. Ratchet wheel 31 includes a plurality of first abutting faces 311 arranged around an external circumference of ratchet wheel 31 Ratchet wheel 31 further includes a plurality of engaging protrusions 312 arranged around the external circumference of ratchet wheel 31. The number of engaging protrusions 312 is equal to the number of first abutting faces 311. First abutting faces 311 are aligned to engaging protrusions 312 and are formed on external faces of engaging protrusions 312, respectively. Further, each first abutting face 311 may extend on each engaging protrusion 312 in a radial direction of rotation axis O.

Pawl 32 is mounted in second compartment 22 and includes a second pivotal portion 321 and a second moving portion 322. Second pivotal portion 321 is disposed in first pivotal portion 221 and is in the form of a cylinder corresponding to first pivotal portion 221. Second pivotal portion 321 has a second sliding face 323 disposed on an external wall of second pivotal portion 321. Second sliding face 323 is slidable in relative to and abuts in face contact with first sliding face 224 to cause pawl 32 in face contact with body 20. Second moving portion 322 includes a second abutting face 324.

Pawl 32 pivots in relative to body 20 about a pivotal axis C while second sliding face 323 slides in relative to the first sliding face 224. Pivotal axis C is parallel to rotation axis O. Second moving portion 322 is mounted in first moving portion 222 and is pivotable in relative to body 20 to cause second abutting face 324 abutting in face contact with one of first abutting faces 311 or disengaging from ratchet wheel 31. A minimum width of neck 223 is less than a maximum width of second pivotal portion 321 along a radial direction of the pivotal axis C.

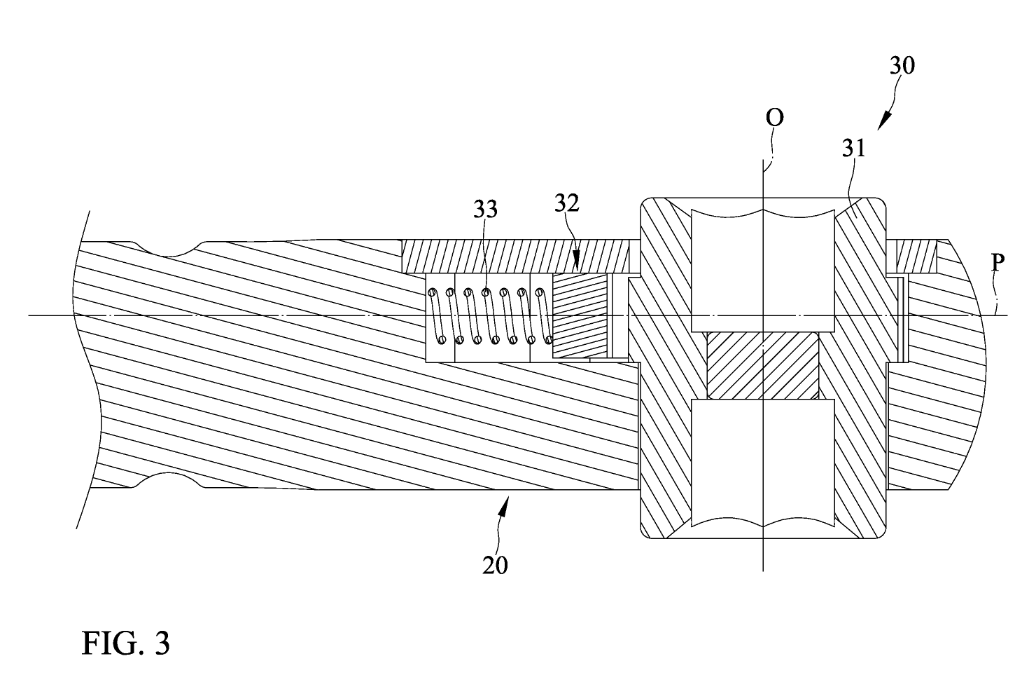

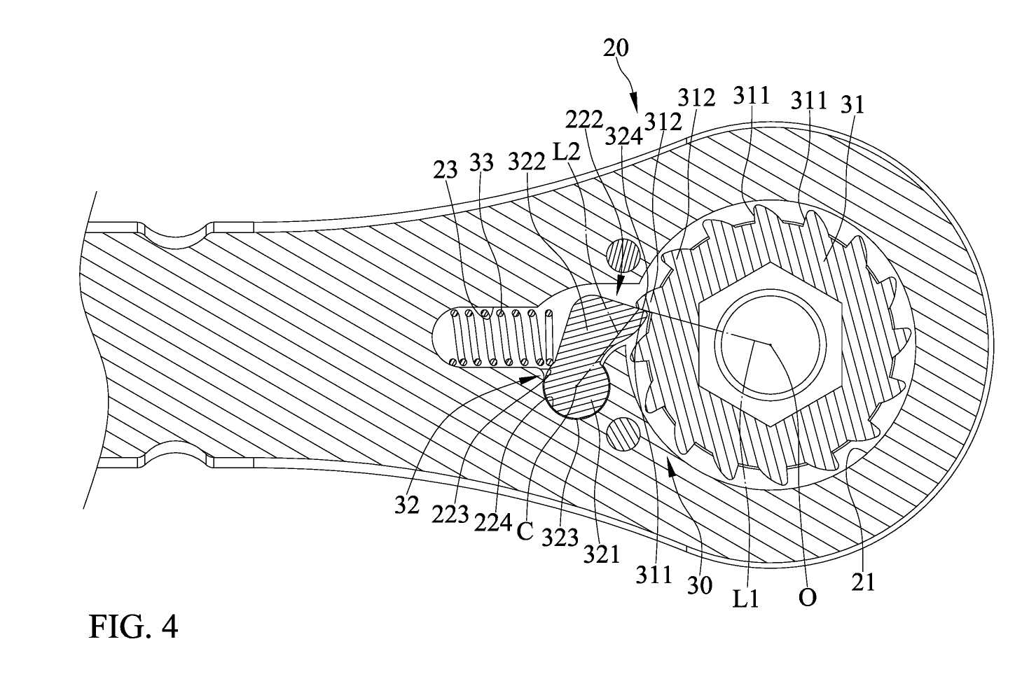

FIGS. 3 and 4 shows a phantom datum plane P perpendicular to rotation axis O and pivotal axis C and passing through first abutting faces 311 and second abutting face 324. A first phantom line L1 on phantom datum plane P is formed between rotation axis O and a contact point between first and second abutting faces 311 and 324. A second phantom line L2 on phantom datum plane P is formed between pivotal axis C and the contact point between first and second abutting faces 311 and 324. An included angle between first and second phantom lines L1 and L2 is greater than 90 degrees and less than 130 degrees. In the embodiment, the included angle between first and second phantom lines L1 and L2 may greater than 110 degrees and less than 120 degrees.

Ratchet device 30 further includes an elastic member 33 disposed in third compartment 23. An end of elastic member 33 abuts a bottom face of third compartment 23 opposite to second compartment 22, and another end of elastic member 33 abuts a side of pawl 32 opposite to ratchet wheel 31.

When the one-way ratchet wrench 10 rotates a fastener, pawl 32 abuts ratchet wheel 31 to prevent ratchet wheel 31 rotating. Further, pawl 32 is in face contact with body 20 to improve the structural strength of ratchet device 30 to cause ratchet device 30 can withstand a reactive force while rotating the fastener. Furthermore, first abutting faces 311 and second abutting face 324 are flat to cause second abutting face 324 in face contact with one of first abutting faces 311 to improve the structural strength of ratchet device 30. Additionally, the included angle between first and second phantom lines L1 and L2 greater than 110 degrees and less than 120 degrees causes that a contact face between body 20 and pawl 32 can perpendicular to the reactive force.

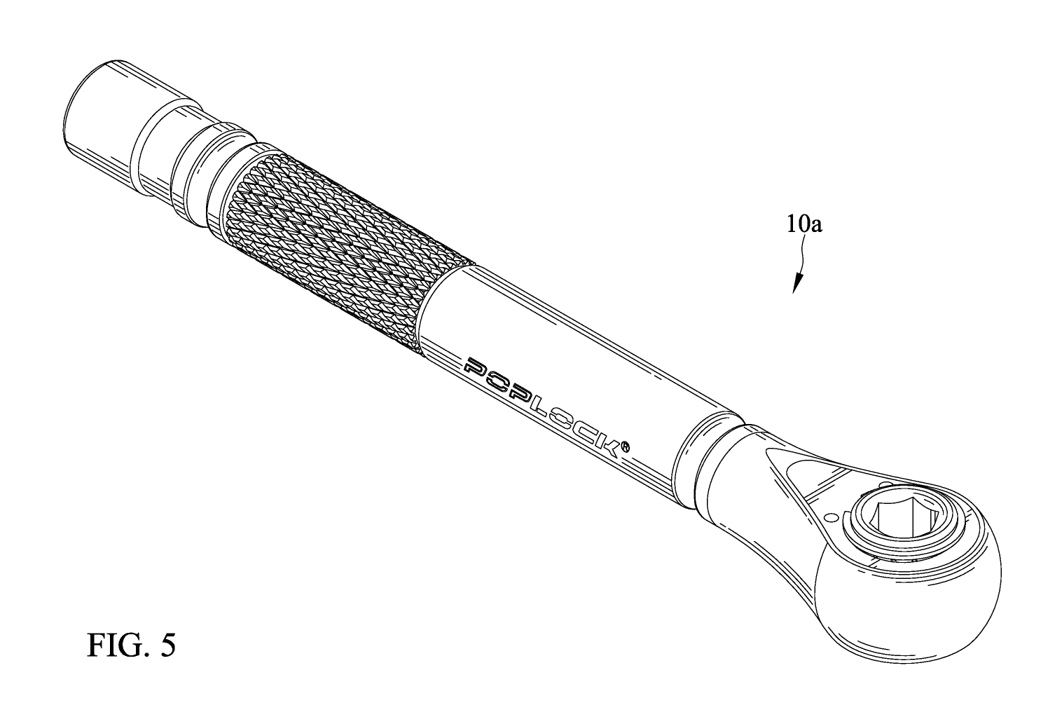

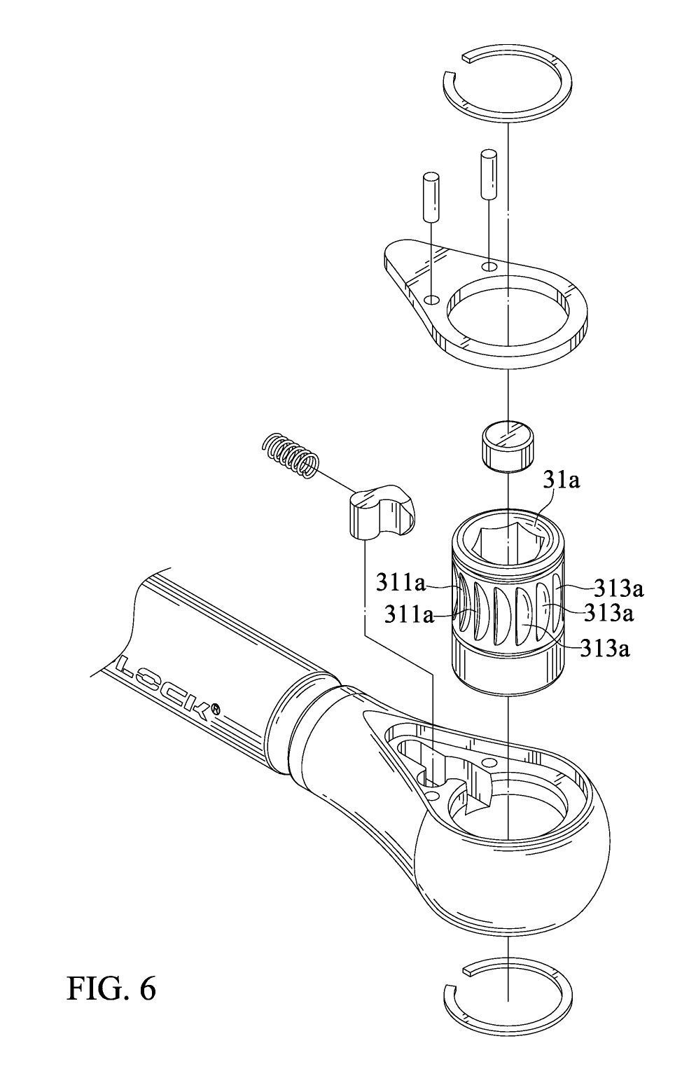

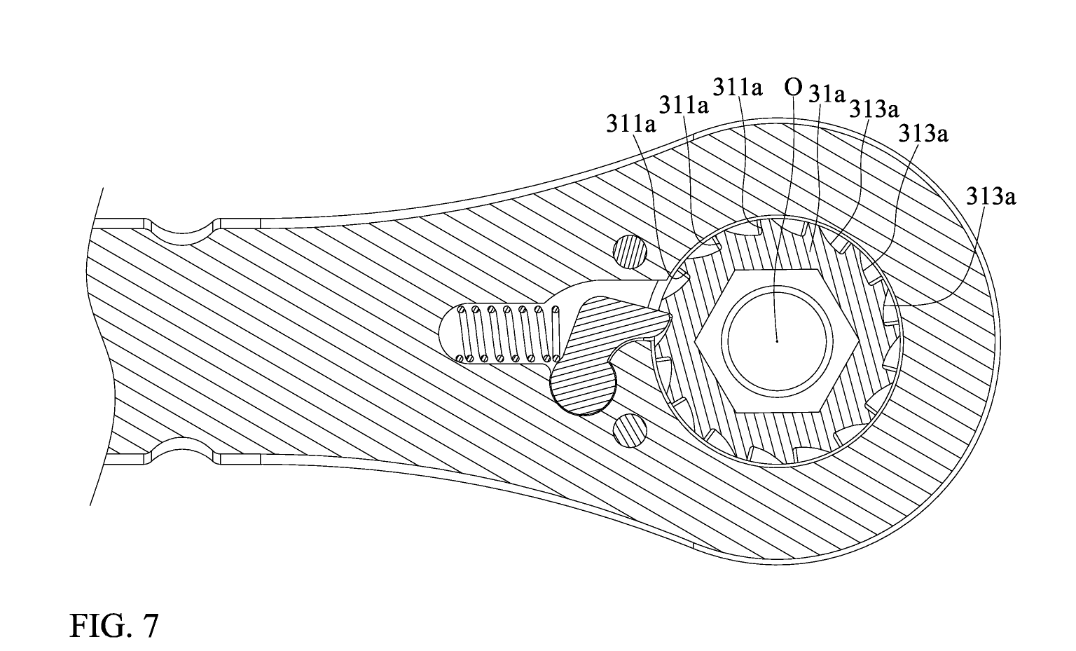

FIGS. 5-7 show a one-way ratchet wrench 10a of a second embodiment according to the present invention. The second embodiment is generally similar to the first embodiment except that ratchet wheel 31a further includes a plurality of engaging recesses 313a arranged around the external circumference of ratchet wheel 31a. The number of engaging recesses 313a is equal to the number of first abutting faces 311a. First abutting faces 311a are aligned to engaging recesses 313a and are formed on internal faces of engaging recesses 313a, respectively.

Thus, the external circumference of ratchet wheel 31a does not have any protruded part. First abutting faces 311a arranged in the ratchet wheel 31a can withstand bigger reactive force.

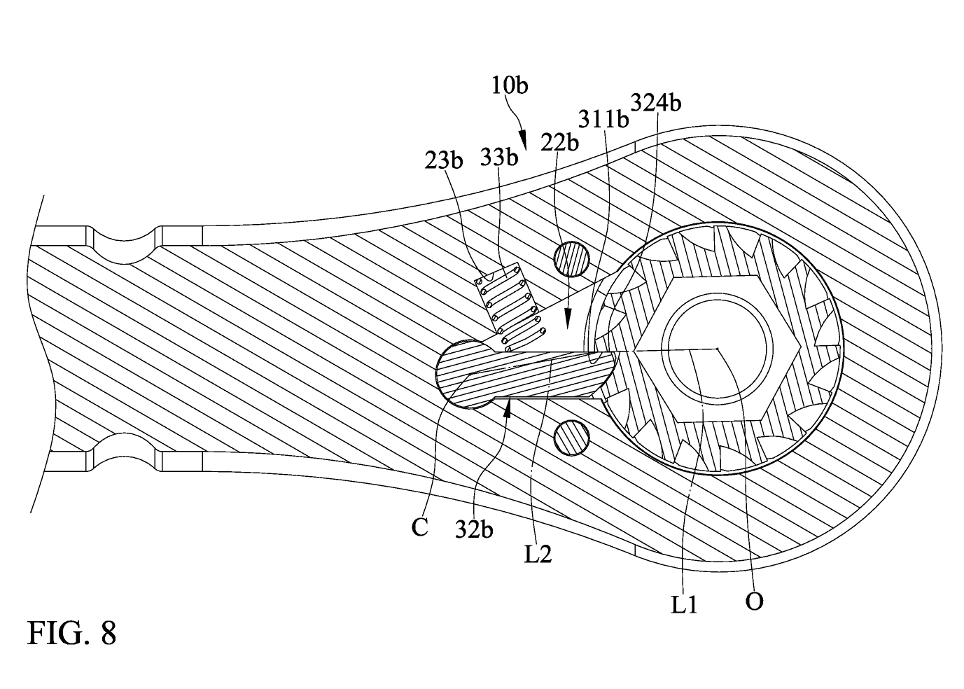

FIG. 8 shows a one-way ratchet wrench 10b of a third embodiment according to the present invention. The third embodiment is generally similar to the first embodiment except that third compartment 23b disposed at a lateral side of second compartment 22b. Elastic member 33b disposed in third compartment 23b. An end of elastic member 33b abuts a bottom face of third compartment 23b opposite to second compartment 22b, and another end of elastic member 33b abuts a lateral side of pawl 32b.

Additionally, first phantom line L1 is formed between rotation axis O and the contact point between first and second abutting faces 311b and 324b. Second phantom line L2 is formed between pivotal axis C and the contact point between first and second abutting faces 311b and 324b. The included angle between first and second phantom lines L1 and L2 is greater than 160 degrees and less than 175 degrees.

While various embodiments have been described above, it should be understood that they have been presented by way of example only, and not limitation. For example, any of the elements associated with the privacy summary may employ any of the desired functionality set forth hereinabove. Thus, the breadth and scope of a preferred embodiment should not be limited by any of the above-described exemplary embodiments.

What is claimed is:

1. A one-way ratchet wrench comprising:
a body including a first compartment and a second compartment, wherein the second compartment includes a first pivotal portion and a first moving portion, wherein the first pivotal portion has a first sliding face disposed on an internal wall of the first pivotal portion, wherein the first compartment and the first moving portion intercommunicate with each other; and
a ratchet device including a ratchet wheel and a pawl, wherein the m ratchet wheel is mounted in the first compartment and is unidirectionally rotatable in relative to the body about a rotation axis, wherein the ratchet wheel includes a plurality of first abutting faces arranged around an external circumference of the ratchet wheel, wherein the pawl is mounted in the second compartment, wherein the pawl includes a second pivotal portion and a second moving portion, wherein the second pivotal portion is disposed in the first pivotal portion, wherein the second pivotal portion has a second sliding face disposed on an external wall of the second pivotal portion, wherein the second sliding face is slidable in relative to and abuts in face contact with the first sliding face, wherein the second moving portion includes a second abutting face, wherein the pawl pivots in relative to the body about a pivotal axis while the second sliding face slides in relative to the first sliding face, and wherein the second moving portion is mounted in the first moving portion and is pivotable in relative to the body to cause the second abutting face abutting in face contact with one of the plurality of first abutting faces or disengaging from the ratchet wheel.

2. The one-way ratchet wrench as claimed in claim 1, wherein the pivotal axis is parallel to the rotation axis.

3. The one-way ratchet wrench as claimed in claim 2, wherein a phantom datum plane is perpendicular to the rotation axis and the pivotal axis and passes through the plurality of first abutting faces and the second abutting face, wherein a first phantom line on the phantom datum plane is formed between the rotation axis and a contact point between the first and second abutting faces, wherein a second phantom line on the phantom datum plane is formed between the pivotal axis and the contact point between the first and second abutting faces, and wherein an included angle between the first and second phantom lines is greater than 90 degrees and less than 130 degrees.

4. The one-way ratchet wrench as claimed in claim 3, wherein the included angle between the first and second phantom lines is greater than 110 degrees and less than 120 degrees.

5. The one-way ratchet wrench as claimed in claim 2, wherein a phantom datum plane is perpendicular to the rotation axis and the pivotal axis and passes through the plurality of first abutting faces and the second abutting face, wherein a first phantom line on the phantom datum plane is formed between the rotation axis and a contact point between the first and second abutting faces, wherein a second phantom line on the phantom datum plane is formed between the pivotal axis and the contact point between the first and second abutting faces, and wherein an included angle between the first and second phantom lines is greater than 160 degrees and less than 175 degrees.

6. The one-way ratchet wrench as claimed in claim 2, wherein the second compartment further includes a neck disposed between the first pivotal portion and the first moving portion, wherein a minimum width of the neck is less than a maximum width of the first pivotal portion and a maximum width of the second pivotal portion along a radial direction of the pivotal axis.

7. The one-way ratchet wrench as claimed in claim 2, wherein the body further includes a third compartment disposed at a side of the second compartment opposite to the first compartment, wherein the third compartment intercommunicates with the first moving portion of the second compartment, wherein the ratchet device further includes an elastic member disposed in the third compartment, wherein an end of the elastic member abuts a bottom face of the third compartment opposite to the second compartment, and wherein another end of the elastic member abuts a side of the pawl opposite to the ratchet wheel.

8. The one-way ratchet wrench as claimed in claim 2, wherein the body further includes a third compartment disposed at a lateral side of the second compartment, wherein the ratchet device further includes an elastic member disposed in the third compartment, wherein an end of the elastic member abuts a bottom face of the third compartment opposite to the second compartment, and wherein another end of the elastic member abuts a lateral side of the pawl.

9. The one-way ratchet wrench as claimed in claim 1, wherein the ratchet wheel further includes a plurality of engaging protrusions arranged around the external circumference of the ratchet wheel, wherein the number of the plurality of engaging protrusions is equal to the number of the plurality of first abutting faces, and wherein the plurality of first abutting faces is aligned to the plurality of engaging protrusions and is formed on external faces of the engaging protrusions.

10. The one-way ratchet wrench as claimed in claim 1, wherein the ratchet wheel further includes a plurality of engaging recesses arranged around the external circumference of the ratchet wheel, wherein the number of the plurality of engaging recesses is equal to the number of the plurality of first abutting faces, and wherein the plurality of first abutting faces is aligned to the plurality of engaging recesses and is formed on internal faces of the engaging recesses.

11. The one-way ratchet wrench as claimed in claim 1, wherein the plurality of first abutting faces and the second abutting face are flat, and wherein the second abutting face is in face contact with one of the plurality of first abutting faces.

12. The one-way ratchet wrench as claimed in claim 1, wherein the first pivotal portion is a round hole, and wherein the second pivotal portion is a cylinder corresponding to the first pivotal portion.
